(19) United States
(12) Patent Application Publication
(10) Pub. No.: US 2005/0111035 A1
(43) Pub. Date: May 26, 2005

(54) Printing apparatus, printing system, printing method, and program therefor

(76) Inventor: Kouichi Takamine, Kawanishi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/986,774

(22) Filed: Nov. 15, 2004

(30) Foreign Application Priority Data
Nov. 20, 2003 (JP) 2003-390553

(51) Int. Cl. G06F 15/00; H04N 1/46

(52) U.S. Cl. 358/1.15; 358/538; 358/1.6

(57) ABSTRACT

A printing system including network terminals 2, 3, 4 and 5 and a printing apparatus 1, the network terminals 2, 3, 4 and 5 requesting the printing apparatus 1, via a network 6, to print data to be printed, and the printing apparatus 1 receiving the data to be printed from the network terminals 2, 3, 4 and 5 and printing the data to be printed. The network terminals 2, 3, 4 and 5 include interface processing units 207, 306, 408 and 507 respectively that transmit the data to be printed to the printing apparatus 1 via the network 6. The data to be printed includes at least one of image data and text data. The printing apparatus 1 includes: an interface processing unit 101 that receives data to be printed from each of the network terminals 2, 3, 4 and 5; a print processing unit 105 that extracts one of, or both, the image data and the text data from the received data to be printed, and generates print data that corresponds to the extracted data; and a printer engine 108 that performs printing of the generated print data.

### BACKGROUND OF THE INVENTION

(1) Field of the Invention

The present invention relates to a printing apparatus, a printing system, a printing method and a program for receiving print data from networked home appliances as host terminals and printing the received data. The present invention aims at (i) network terminals such as a printer like an inkjet printer or an electrophotographic printer; a digital camera; a portable terminal (including one equipped with a digital camera) like a cell phone or a personal digital assistance (PDA); a storage device like a digital versatile disk (DVD) equipped with a network function; and a digital television receiver that is capable of receiving broadcasting satellite (BS) digital broadcasts and terrestrial digital broadcasts, and (ii) a printing apparatus that receives data to be printed from such network terminals and prints the received data to be printed.

(2) Description of the Related Art

Conventionally, printing processes performed by a printing apparatus vary depending on host terminals such as a personal computer and a digital camera, and each printing apparatus has its own printing functions and printing capabilities specific to a single host terminal. For example, in the case where a personal computer is a host terminal, the printer driver of the host terminal generates print data and transmits it to the printing apparatus, while the printing apparatus performs the printing process of the print data upon receipt of it. In the case where a digital camera is a host terminal, the host terminal transmits image data of Digital Print Order Format (DPOF) to the printing apparatus, while the printing apparatus generates print data from the received image data and performs the printing process of it. As networks expand not only in the office but also in the home, digital home appliances have been connected to such networks. Against this backdrop, there is a demand for a printing apparatus that is capable of performing the optimum printing process for each of various host terminals, including printing of print data transmitted from such digital home appliances connected to networks (hereinafter referred to as “networked home appliances”), in accordance with their system For example, Japanese Laid-Open Patent Application Publication No. 2002-236563 (pp. 1-10, FIG. 1 and FIG. 2) shows, as a related art, the system including an image information processing apparatus and an image forming apparatus, in which it is possible to change speedily and flexibly the mode of transmitting image information from the image information processing apparatus to the image forming apparatus, in accordance with various states of the image forming apparatus, for example, the state in which a new model differs from an old model in the order of transferring data (page source data), and the state in which available RAM space of a printer is small. In other words, in this conventional system, the mode of transmitting the image information is changed in accordance with the various states of the image forming apparatus by changing the processing performed by the image information processing apparatus that is a host terminal.

However, networked home appliances do not have so much versatility, in the sense of a printing system to be applied to such networked home appliances and a printing apparatus, as an image information processing apparatus such as a personal computer. Since the networked home appliances have a limited number of functions, it is difficult to equip them with the same level of versatility as the personal computer. So the printing apparatus needs to have functions for flexibly supporting various host terminals equipped with different print processing functions. In sum, there is a problem that the conventional printing apparatus is not capable of flexibly supporting various host terminals equipped with different print processing functions.

### SUMMARY OF THE INVENTION

The present invention has been conceived in order to solve the above problem, and an object of the present invention is to provide a printing apparatus, a printing system, a printing method and a program that allow flexible support of various host terminals equipped with different print processing functions.

In order to achieve the above object, the printing apparatus according to the present invention is a printing apparatus that is connected to a network terminal via a network, comprising: a receiving unit operable to receive data to be printed from the network terminal, the data to be printed including at least one of image data and text data; a print data generating unit operable to extract one of, or both, the image data and the text data from the received data to be printed, and generate print data that corresponds to the extracted data; and a printing unit operable to perform printing of the generated print data.

It is also possible that the above-mentioned printing apparatus further comprise an analyzing unit operable to analyze whether a type of data included in the data to be printed is the image data or the text data, wherein the print data generating unit generates the print data after performing a pre-process appropriate for the type of data based on a result of the analysis by the analyzing unit.

According to the above configuration, it becomes possible for the printing apparatus to automatically identify data to be printed of different types and print them depending on the types of the data.

In addition, the analyzing unit analyzes the type of data based on a file extension included in the data to be printed. The analyzing unit also analyzes whether or not the data to be printed has already been converted into print data, based on a communication between the receiving unit and the network terminal.

In the case where the analyzing unit analyzes that the data to be printed has already been converted into print data, the printing unit performs printing of the data to be printed without any processing.

By doing so, in the case where data to be printed has already been converted into print data, it becomes possible to perform printing of the data to be printed without executing the print data generation process.

The analyzing unit further judges whether or not a print style of the data to be printed is predetermined. More specifically, it is determined whether or not the print style is predetermined based on whether or not the data to be printed includes a description of a file name of a style sheet with an extension such as xsl and css.

The printing apparatus according to the present invention further comprises a style sheet searching unit operable to (i) search the printing apparatus for a style sheet that defines the predetermined print style of the data to be printed in the case where the analyzing unit judges that said print style is predetermined, and (ii) request the network terminal that has transmitted the data to be printed to transmit the style sheet that defines the predetermined print style in the case where said style sheet is not found in the printing apparatus as a result of the search, wherein the print data generating unit generates the print data based on the style sheet obtained as a result of the search or the request by the style sheet searching unit.

As described above, in the case where the print style of data to be printed is predetermined, the print data is generated by applying the style sheet that defines the predetermined print style to the data to be printed.

The printing apparatus according to the present invention further comprises a style sheet holding unit operable to hold a plurality of style sheets, each of which defines a specific print style for printing data to be printed depending on a type of data included in the data to be printed, wherein in the case where the analyzing unit judges that the print style of the data to be printed is not predetermined, the print data generating unit generates the print data according to a specific print style defined by one of the plurality of style sheets held in the style sheet holding unit.

As described above, even in the case where the print style of data to be printed is not predetermined, it is possible to generate the print data by applying the print style stored in the memory to the data to be printed, based on the data type analyzed by the analyzing unit.

Furthermore, the above style sheet holding unit holds at least a text style sheet that defines a print style for printing a text only and an image style sheet that defines a print style for printing an image only, and in the case where the data to be printed includes both the text data and the image data, the print data generating unit (i) generates print data of the text data included in the data to be printed according to the print style defined by the text style sheet, and (ii) generates print data of the image data included in the data to be printed according to the print style defined by the image style sheet, so that the print data of the text data and the print data of the image data are printed on separate pages.

By doing so, even in the case where data to be printed includes both text data and image data, it is possible to extract the text data and the image data separately for printing.

The above selecting unit sends a notification to the user in the case where the data to be printed includes both the text data and the image data, and inquires the user about whether or not the image data and the text data should be printed on the same page.

By doing so, in the case where data to be printed includes both text data and image data, it is possible to determine, according to a user's instruction, whether or not the text data and the image data should be printed on the same page, and perform the printing of these data.

In the case where the printing apparatus receives, as a result of the inquiry, an instruction from the user that the text data and the image data should not be printed on the same page, the print data generating unit (i) generates the print data for printing a text only from the text data included in the data to be printed, and (ii) generates the print data for printing an image only from the image data included in the data to be printed, so that the print data of the text data and the print data of the image data are printed on separate pages.

By doing so, it is possible to perform the processing of data to be printed including both text data and image data in complying with a user's intention.

The printing system according to the present invention is a printing system comprising a network terminal and a printing apparatus that are connected to each other via a network, the network terminal requesting the printing apparatus to print data to be printed, and the printing apparatus receiving the data to be printed from the network terminal and printing said data to be printed, wherein the network terminal includes a communicating unit operable to transmit the data to be printed to the printing apparatus via the network, and the printing apparatus includes: a receiving unit operable to receive the data to be printed from the network terminal, the data to be printed including at least one of image data and text data; a print data generating unit operable to extract one of, or both, the image data and the text data from the received data to be printed, and generate print data that corresponds to the extracted data; and a printing unit operable to perform printing of the generated print data.

According to the above configuration, it is possible to realize a printing system for performing printing appropriate to data to be printed including various types of data that is transmitted from the network terminal connected to the printing apparatus via a network.

The above network terminal further includes: a memory operable to hold the data to be printed and a style sheet that defines the print style of the data to be printed; and a searching unit operable to search the memory for the style sheet when receiving a request for said style sheet from the printing apparatus, the printing apparatus further includes: a style sheet holding unit operable to hold at least a text style sheet that defines a print style for printing a text only and an image style sheet that defines a print style for printing an image only; and a style sheet searching unit operable to (i) search the style sheet holding unit for a style sheet that defines the predetermined print style of the data to be printed in the case where the analyzing unit judges that said print style is predetermined, and (ii) request the network terminal that has transmitted the data to be printed to transmit the style sheet that defines the predetermined print style of the data to be printed in the case where said style sheet is not found in the style sheet holding unit as a result of the search, and the print data generating unit generates the print data based on the style sheet obtained as a result of the search or the request by the style sheet searching unit.

By doing so, it is possible to realize a printing system for searching within the printing apparatus and the network terminal to obtain the print style sheet associated with the data to be printed that is transmitted from the network terminal and performing printing of the data, in the case where it is determined that the print style of data to be printed is predetermined,

The above printing apparatus further includes a style sheet holding unit operable to hold at least a text style sheet that defines a print style for printing a text only and an image style sheet that defines a print style for printing an image only, the above network terminal further includes: a displaying unit operable to display style sheets held in the style sheet holding unit; and an inputting unit operable to input a style sheet selected by a user from among the displayed style sheets, and in the printing apparatus, the print data generating unit generates the print data according to a print style defined by the style sheet selected by the user in the case where the analyzing unit judges that the print style of the data to be printed is not predetermined.

By doing so, it is possible to realize a printing system for performing printing of the data to be printed that is transmitted from the network terminal, by applying the optimum print style sheet selected in complying with a user's intention from among various print style sheets that define print styles and are stored in the memory, even in the case where the print style sheet of data to be printed is not predetermined.

Note that the above network terminal further includes an inquiring unit operable to send a notification to a user in the case where the data to be printed includes both the text data and the image data, and inquire the user about whether or not the image data and the text data should be printed on the same page, and in the case where the printing apparatus receives, as a result of the inquiry by the inquiring unit, an instruction from the user that the text data and the image data should not be printed on the same page, the print data generating unit (i) generates the print data for printing a text only from the text data included in the data to be printed, and (ii) generates the print data for printing an image only from the image data included in the data to be printed, so that the print data of the text data and the print data of the image data are printed on separate pages.

By doing so, it becomes possible to realize a printing system for performing printing of the data to be printed so that the text data and the image data be printed on separate pages according to a user's instruction, even in the case where data to be printed that is transmitted from the network terminal includes both text data and image data.

Furthermore, the printing method according to the present invention is a printing method by which a network terminal transmits data to be printed and a request for printing the data to be printed to a printing apparatus via a network and the printing apparatus receives and prints said data to be printed, the method comprising: in the network terminal, transmitting the data to be printed to the printing apparatus via the network; in the printing apparatus, receiving the data to be printed from the network terminal, the data to be printed including at least one of image data and text data; extracting one of, or both, the image data and the text data from the received data to be printed, and generating print data that corresponds to the extracted data to be printed; and printing the generated print data.

By doing so, it becomes possible to realize a printing method for performing printing of data to be printed of different types that are transmitted from the network terminal connected to the printing apparatus via a network.

In the above printing apparatus, at least a text style sheet that defines a print style for printing a text only and an image style sheet that defines a print style for printing an image only are previously held in a style sheet holding unit, and in the generation of the print data, the print data is generated according to a print style of one of the held style sheets, in the case where it is judged in the analysis that the print style of the data to be printed is not predetermined.

By doing so, it becomes possible to realize a printing method for performing printing of the data to be printed, by applying the optimum print style sheet selected in complying with a user's intention from among various print style sheets that define print styles and are stored in the memory, even in the case where the print style sheet of data to be printed that is transmitted from the network terminal is not predetermined.

Note that, in the above network terminal, the data to be printed and a style sheet that defines a print style of the data to be printed are previously held in a memory, in the printing apparatus, at least a text style sheet that defines a print style for printing a text only and an image style sheet that defines a print style for printing an image only are previously held in a style sheet holding unit, the method according to the present invention further comprises: (i) searching the style sheet holding unit for the style sheet that defines the predetermined print style of the data to be printed in the case where it is judged in the analysis that said print style is predetermined, and (ii) requesting the network terminal that has transmitted the data to be printed to transmit the style sheet that defines the predetermined print style in the case where said style sheet is not found in the style sheet holding unit; and searching the memory for the style sheet when receiving the request for said style sheet from the printing apparatus, and in the generation of the print data, the print data is generated based on the style sheet obtained as a result of the search or the request.

By doing so, it is possible to realize a printing method for searching within the printing apparatus and the network terminal to obtain the print style sheet associated with the data to be printed and performing printing of the data, in the case where it is determined that the print style sheet of data to be printed that is transmitted from the network terminal is predetermined.

The printing method according to the present invention further comprises, in the above network terminal, sending a notification to a user in the case where the data to be printed includes both the text data and the image data, and inquiring the user about whether or not the image data and the text data should be printed on the same page, wherein in the case where, as a result of the inquiry, the printing apparatus receives an instruction from the user that the text data and the image data should not be printed on the same page, in the generation of the print data, (i) the print data is generated for printing a text only from the text data included in the data to be printed, and (ii) the print data is generated for printing an image only from the image data included in the data to be printed, so that the print data of the text data and the print data of the image data are printed on separate pages.

By doing so, it becomes possible to realize a printing method for performing printing of the data to be printed so that the text data and the image data are printed on separate pages according to a user's instruction, even in the case where data to be printed that is transmitted from the network terminal includes both text data and image data.

The program according to the present invention is a program for a printing apparatus that is connected to a network terminal via a network, the program causing a computer to function as: a receiving unit operable to receive data to be printed from the network terminal, the data to be printed including at least one of image data and text data; a print data generating unit operable to extract one of, or both, the image data and the text data from the received data to be printed, and generate print data that corresponds to the extracted data; and a printing unit operable to perform printing of the generated print data.

In addition, the program according to the present invention is a program for a network terminal that transmits data to be printed and a request for printing the data to be printed to a printing apparatus via a network so as to cause the printing apparatus to print said data to be printed, the program causing a computer to function as: a communicating unit operable to transmit the data to be printed to the printing apparatus; a memory operable to hold the data to be printed and a style sheet that defines a print style of the data to be printed; a style describing unit operable to describe a file name with an extension indicating the style sheet on the data to be printed; and a searching unit operable to search the memory for the style sheet when receiving a request for said style sheet from the printing apparatus.

The printing apparatus, the printing system, the printing method and the program therefor according to the present invention have the effect of realizing printing of data to be printed of various data types written in various languages by applying various print styles to these data to be printed, based on the result of analyzing the markup languages of these data to be printed.

Note that not only is it possible to embody the present invention as a variety of printing apparatuses, but also as a variety of printing methods that include, as steps, the characteristic units included in such apparatuses, and as programs that causes a computer to execute these steps. It should also be noted that such programs can be distributed on a recording medium such as a CD-ROM (Compact Disc-Read Only Memory) and via a transmission medium such as the Internet.

As further information about technical background to this application, the disclosure of Japanese Patent Application No. 2003-390553 filed on Nov. 20, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing schematically a configuration of a network system according to an embodiment of the present invention, including a printing apparatus and networked home appliances such as a digital camera, a digital television receiver and a cell phone and a terminal device such as a personal computer;

FIG. 2 is a diagram showing a tree of folders of a memory that holds data to be printed according to the embodiment of the present invention;

FIG. 3 is a schematic flowchart of processing of print data performed by the printing apparatus according to the embodiment of the present invention;

FIG. 4 is a flowchart of processing for analysis of an extension and a markup language and judgment of whether printing is possible or not according to the embodiment of the present invention;

FIG. 5 is a flowchart of processing for analysis of the number of image data included in data to be printed according to the embodiment of the present invention;

FIG. 6 is a flowchart of processing for adjustment of an image size in the case of printing image data only and printing both image data and text data according to the embodiment of the present invention;

FIG. 7 is a diagram showing examples of print data generated based on various print styles which are previously stored in the memory according to the embodiment of the present invention. In more detail, (a) shows one example of print data which is printed based on a print style that corresponds to printing of text data only; (b) shows one example of print data which is printed based on a print style in which one image data is inserted into one page in the case of printing both text data and image data; (c) shows one example of print data which is printed based on a print style in which two image data are inserted into one page in the case of printing both text data and image data; (d) shows a variation of the print data shown in FIG. 7C; and (e) shows one example of print data which is printed based on a print style in which four image data are inserted into one page in the case of printing the image data only;

FIG. 8 is a diagram showing one example of a print style sheet for data to be printed which is written in XHTML1.1; and

FIG. 9 shows one example of print data which is printed by applying the print style defined as shown in FIG. 8.

### DESCRIPTION OF THE PREFERRED EMBODIMENT(S)

Referring to the drawings, the following describes the embodiment of the present invention in detail.

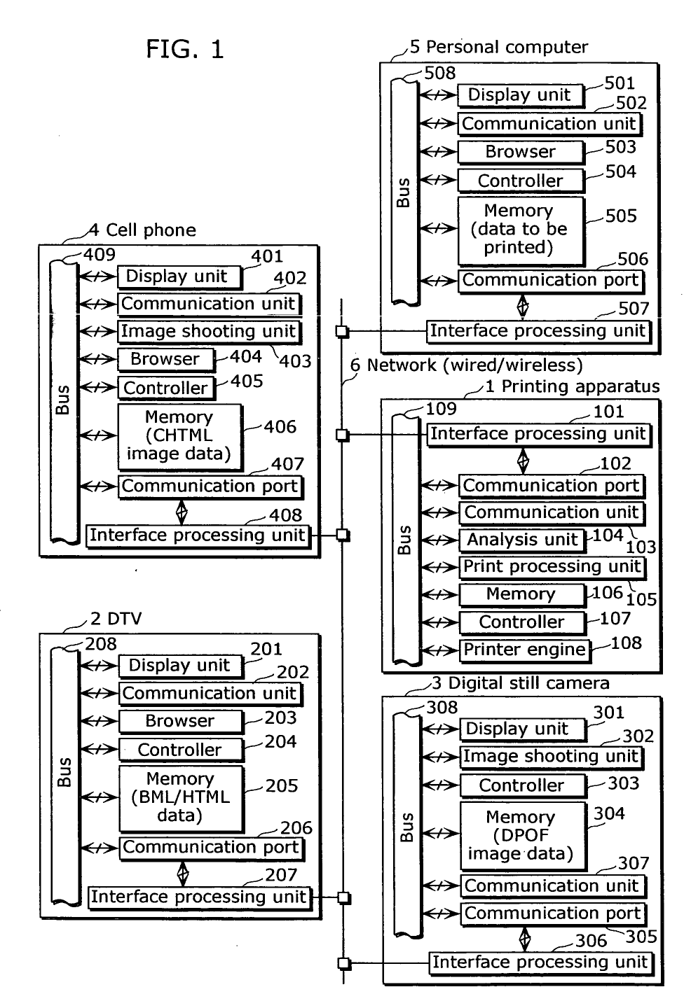

FIG. 1 is a block diagram showing schematically a configuration of a network system according to an embodiment of the present invention, including a printing apparatus, networked home appliances such as a digital camera, a digital television set and a cell phone, and a terminal device such as a personal computer. In FIG. 1, a printing apparatus 1 includes an interface processing unit 101, a communication port 102, a communication unit 103, an analysis unit 104, a print processing unit 105, a memory 106, a controller 107, and a printer engine 108.

The printing apparatus 1 is connected to a wired or a wireless network 6 in order to receive data to be printed and the like from network terminal devices. As such network terminal devices, networked home appliances such as a digital television receiver 2, a digital still camera 3 and a cell phone 4, and a personal computer 5, are connected to the network 6.

The operation of the printing apparatus 1 is roughly described below. The interface processing unit 101 performs protocol processing for connection to the network 6. The communication port 102 performs processing for connecting to a plurality of terminal devices at the same time, which allows the printing apparatus 1 to communicate with the plurality of terminal devices connected to the network 6 at the same time. The communication unit 103 receives data to be printed from the network terminal devices such as the digital television receiver (DTV) 2, the digital still camera (DSC) 3, the cell phone 4 and the personal computer 5, and stores them into the memory 106. The memory 106 holds print layout patterns and others as well as the above data to be printed. The analysis unit 104 analyzes the types of the data to be printed that are stored in the memory 106. For example, the analysis unit 104 analyzes the following types of data: data written in Broadcast Markup Language (BML) and data written in Hyper Text Markup Language (HTML) for the DTV 2; DPOF image data for the digital still camera 3; data written in Compact Hyper Text Markup Language (CHTML) and images in compliance with Joint Photographic Experts Group (JPEG) for the cell phone 4; and data written in HTML and data of application software (such as data related to Microsoft Office) that runs on the operating system (OS) for the personal computer 5. The print processing unit 105 selects an appropriate print processing method from among a plurality of print processing methods in accordance with the analysis result by the analysis unit 104, executes the selected method, and generates print data. The controller 107 controls reception of data to be printed, analysis of types of data to be printed, print processing and the like. The printer engine 108 executes printing based on the print data generated by the print processing unit 105.

In FIG. 1, the DTV2 includes a display unit 201, a communication unit 202, a browser 203, a controller 204, a memory 205, a communication port 206 and an interface processing unit 207.

The operation of the DTV 2 is roughly described below. The communication unit 202 receives television broadcast signals. The communication port 206 receives contents located on the Internet via the interface processing unit 207 and the network 6. The browser 203 has a function (WWW browser function) of displaying digital broadcast data written in BML and contents located on the Internet and written in HTML. The display unit 201 outputs for displaying the contents on which the browser 203 performs the processing. The memory 205 holds data to be printed such as BML data and HTML data. The controller 204 controls reception of television broadcast signals and Internet information and transmission of data to be printed.

In FIG. 1, the DSC 3 includes a display unit 301, an image shooting unit 302, a controller 303, a memory 304, a communication port 305, a communication unit 307 and an interface processing unit 306.

The operation of the DSC 3 is roughly described below. The image shooting unit 302 shoots images of subjects. The shot image data are recorded in the memory 304 in Digital Print Order Format (DPOF) that is one of the recording formats for digital cameras. The display unit 301 is used for confirmation of the subjects when shooting the images of them using the image shooting unit 302 and confirmation of the image data recorded in the memory 304. The communication unit 307 of the DSC 3 transmits the image data to the printing apparatus 1 via the communication port 305, the interface processing unit 306 and the network 6. The controller 303 controls shooting of the images of the subjects by the image shooting unit 302, recording of the shot image data, display of the image data, transmission of the image data and others.

In FIG. 1, the cell phone 4 includes a display unit 401, a communication unit 402, an image shooting unit 403, a browser 404, a controller 405, a memory 406, a communication port 407 and an interface processing unit 408.

The operation of the cell phone 4 is roughly described below. The communication unit 402 receives voice calls and contents written in Compact Hyper Text Markup Language (CHTML) via a cell phone base stations not illustrated in FIG. 1. The image shooting unit 403 is a digital still camera that is mounted into the cell phone 4 and shoots the images of the subjects. The browser 404 has a function of displaying function-switch menus of the cell phone 4 and contents written in CHTML. The display unit 401 outputs and displays the contents processed by the browser 404. The memory 406 holds data to be printed such as data written in CHTML, image data shot by the image shooting unit 403, image data and text data attached to e-mails received by the e-mail function of the cell phone. The cell phone 4 transmits the data to be printed to the printing apparatus 1 via the communication port 407, the interface processing unit 408 and the network 6. The controller 405 controls calls over the cell phone 4, receiving of CHTML contents, sending and receiving of e-mails, transmitting of data to be printed, and the like.

In FIG. 1, the personal computer 5 includes a display unit 501, a communication unit 502, a browser 503, a controller 504, a memory 505, a communication port 506, an interface processing unit 507.

The operation of the personal computer 5 is roughly described below. The communication unit 502 receives contents written in Hyper Text Markup Language (HTML), document data created by application software such as word processing software, image data shot by digital still cameras and others, from an Internet Services Provider (ISP), other computers on the network and others via the communication port 506, the interface processing unit 507 and the network 6. The document data is sometimes created by the personal computer 5 itself. The browser 503 has a function of displaying contents written in HTML and document data created by word processing software or the like. The display unit 501 outputs and displays the contents processed by the browser 503, the document data created by the word processing software or the like. The memory 505 holds data to be printed such as data written in HTML, image data and document data. The personal computer 5 transmits the data to be printed to the printing apparatus 1 via the communication port 506, the interface processing unit 507 and the network 6. The controller 504 controls receiving of HTML contents, image data, document data and the like, transmitting of e-mails by an e-mail application not illustrated in FIG. 1, data to be printed, and the like.

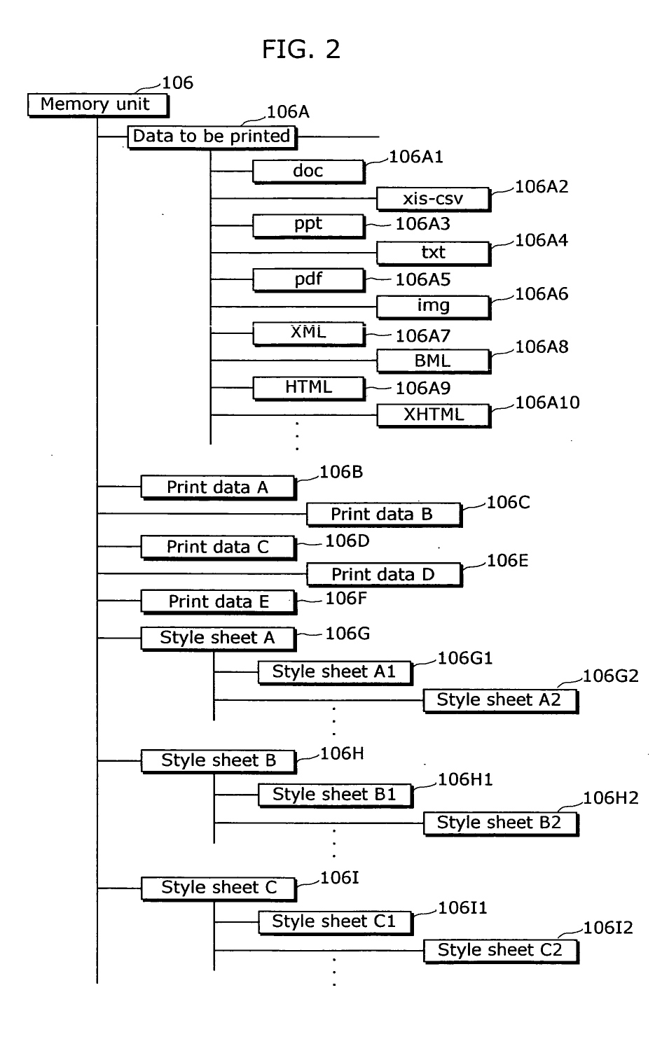

Next, analysis of a type of data to be printed received by the printing apparatus 1 from each host terminal is described by referring to FIG. 1 and FIG. 2. FIG. 2 is a diagram showing a tree of folders of the memory that holds data to be printed.

The interface processing unit 101 performs processing for establishing a connection in response to the access from a network terminal device outside the printing apparatus 1, and inquires the controller 107 about whether or not to start receiving data to be printed, via the communication port 102.

The controller 107 judges whether or not it is possible to receive the data to be printed, depending on the current processing state. When it is possible, the controller 107 instructs the interface processing unit 101 to start receiving the data to be printed from the network terminal device outside the printing apparatus 1. Then, the controller 107 stores the received data to be printed into the folder 106A “data to be printed” of the memory 106.

The analysis unit 104 analyzes the format of the data to be printed stored in the memory 106. To be more specific, the analysis unit 104 examines the rightmost extension delimited by a period “.” out of the file name of the data to be printed, and classifies the data to be printed based on the examined extension. The data to be printed is classified, based on its extension and markup language, into, for example, “doc” if it is data created by Microsoft Word®, “xls-csv” if it is data created by Microsoft Excel, “ppt” if it is data created by Microsoft PowerPoint, “txt” if it is data including text data only, “pdf” if it is Portable Document Format (PDF) data, “img” if it is image data such as jpg, bmp, png, gif and tiff, “XML” if it is data written in eXtensible Markup Language (XML), “BML” if it is data written in Broadcast Markup Language (BML), “HTML” if it is data written in HyperText Markup Language (HTML), and “XHTML” if it is data written in extensible HyperText Markup Language (XHTML). The printing apparatus 1 needs only be equipped with an operating system (OS) such as MS-DOS, Windows®, OS/2, UNIX® and LINUX, in order to identify the above-mentioned file extensions.

Generally speaking, it is possible to identify the details of various formats of files as data to be printed using applications that support respective extensions. There are the following formats of files that can be handled as data to be printed: Office documents that are widely used industry standard data formats (such as Microsoft Word, Microsoft Excel, Microsoft PowerPoint, Adobe PDF); HTML; various image formats; and the like. Since only a part of functions of these applications that support various formats of files are required for printing, it is inefficient to install all these applications that support respective extensions into the printing apparatus. Recently a browser that supports a plurality of file formats has appeared. By incorporating this browser that supports a plurality of data formats, namely, a browser function for identifying the details of the data created by a plurality of different applications, into the printing apparatus, it becomes possible to identify data formats and extract text data and image data included in these data files more efficiently than installing a plurality of applications that support respective file formats. Here, a part of the browser function that supports various file formats shall be an information obtaining unit that obtains information included in data to be printed (i.e., text data and image data).

The controller 107 classifies data to be printed, based on data formats as a result of the analysis by the analysis unit 104, into folders for respective data formats, such as the folders “doc” 106A1, “xls-csv” 106A2, “ppt” 106A3, “txt” 106A4, “pdf” 106A5, “img” 106A6, “XML” 106A7, “BML” 106A8, “HTML” 106A9, “XHTML” 106A10 and the like.

According to the present invention, the memory 106 previously holds style sheets for respective classified data formats in the folders “style sheet A” 106G, “style sheet B” 106H and “style sheet C” 106I. In the folder “style sheet A” 106G, a “style sheet A1” 106G1, a “style sheet A2” 106G2 and the like are stored. In the folder “style sheet B” 106H, a “style sheet B1” 106H1, a “style sheet B2” 106H2 and the like are stored. And in the folder “style sheet C” 106I, a “style sheet C1” 106I1, a “style sheet C2” 106I2 and the like are stored.

The following Table 1 shows the relationship between data formats and style sheets applicable thereto.

TABLE 1

| | | | | style | |
|---|---|---|---|---|---|
| data format | style A | style B | style C | attached | style applied |
| (1) doc | ◯ | ◯ | ◯ | — | — |
| (2) xls.csv | ◯ | ◯ | ◯ | — | — |
| (3) ppt | ◯ | ◯ | ◯ | — | — |
| (4) txt | ◯ | — | — | — | — |
| (5) pdf | ◯ | ◯ | ◯ | — | — |
| (6) jpg, bmp, | — | ◯ | — | — | — |
| png, gif, tiff | | | | | |
| (7) XML, BML, | ◯ | ◯ | ◯ | ◯ | — |
| HTML, XHTML | | | | | |
| (8) converted | — | — | — | — | ◯ |
| print data | | | | | |

* ◯ indicates that the style sheet supports the data format.
*“Style attached” indicates that the style is specified by the terminal that has transmitted data to be printed together with the style sheet attached to the data.

In Table 1, the items in the column indicate data formats. “doc” in the data format (1) is an extension of data created by Microsoft Word. “xis” and “csv” in the data format (2) is extensions of data created by Microsoft Excel. “ppt” in the data format (3) is an extension of data created by Microsoft PowerPoint. “txt” in the data format (4) is an extension of document data including text only. “pdf” in the data format (5) is an extension of PDF document data created by Adobe Acrobat of Adobe Systems, Inc. “png”, “jpg”, “gif”, “bmp” “tiff” and the like in the data format (6) are extensions of image data. “XML”, “BML”, “HTML” and “XHTML” in the data format (7) are data markup languages. The data in the data format (8) are print data which has been already converted from data to be printed by a printer driver of a terminal such as a personal computer that transmitted the data to be printed. It should be noted that above Table 1 shows examples of extensions and markup languages of data that can be handled as data to be printed, and the present invention is not limited to these examples. It is possible to handle, as data to be printed, any data from which text data and image data can be extracted, by adding the extension of the data to the list of data formats.

Next, the relationship between the extensions and markup languages of data to be printed and the style sheets is described below by referring to Table 1. In Table 1, the items in the row indicate the types of style sheets. The style sheet A defines output styles of text only. The style sheet B defines output styles of graphics or images. The style sheet C defines output styles of documents including both text and graphics or both text and images.

Since the data formats (1), (2) (3) and (7) include formatted text data and graphics, any of the styles A, B and C is applied to them, as shown in Table 1. It should be noted that the data in the data format (7) is attached with the style sheet that defines the style of print output, and the attached style is sometimes applied to the data. Since the data in the data format (4) is text data only, the style A is applied to it. Since the data in the data format (5) sometimes includes editable text data, any of the styles A, B and C is applied to the data as is the case with the data in the data formats (1), (2) and (3). Since the data in the data format (6) is image data, the style B is applied to it. Since the data in the data format (8) has already been converted into print data, it is possible to perform print processing on the data as it is. In more detail, in the case where data to be printed corresponds to the data in the data format (8), the print processing unit 105 performs print processing on the data to be printed as it is and outputs it.

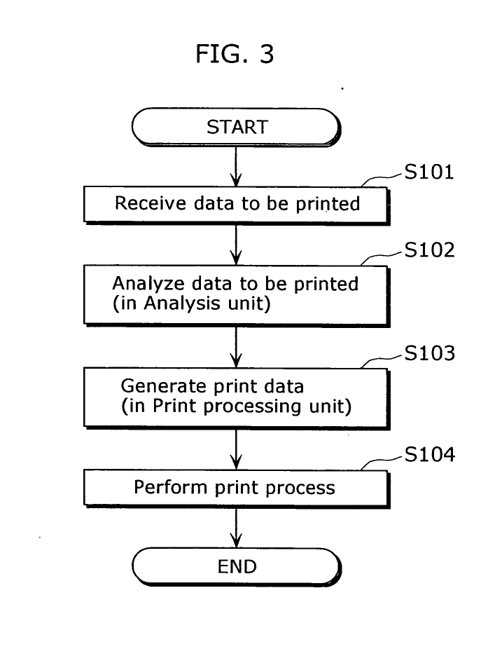

Next, a flow of processing of print data in the printing apparatus is roughly described by referring to FIG. 3.

The printing apparatus 1 performs a receiving process of data to be printed when the data to be printed is transmitted from a network terminal such as the DTV 2, the digital still camera 3, the cell phone 4 and the personal computer 5 (Step S101 in FIG. 3).

After finishing receiving the data to be printed, the analysis unit 104 analyzes the data format of the data to be printed (Step S102 in FIG. 3).

The print processing unit 105 generates print data by applying an appropriate print style, if necessary, based on the result of analysis by the analysis unit 104 (Step S103 in FIG. 3).

The printer engine 108 receives the print data from the print processing unit 105 and prints it out (Step S104 in FIG. 3).

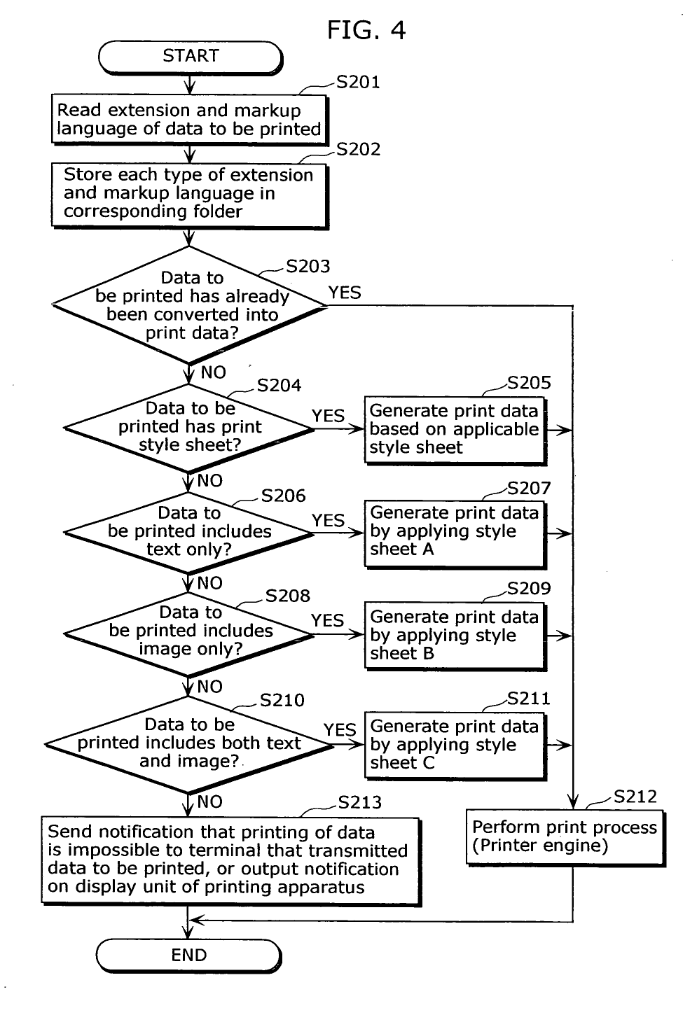

Next, analysis of an extension and a markup language of data to be printed and judgment of whether printing is possible or not are described below by referring to FIG. 4.

The analysis unit 104 reads the extension and markup language of data to be printed (Step S201 in FIG. 4). To be more specific, it reads the rightmost extension delimited by a period “.” out of the file name of the data to be printed which is temporarily stored in the memory 106.

The analysis unit 104 judges to which item the extension and markup language of the data to be printed correspond, from among the data formats indicated in Table 1, namely, “doc”, “xls”, “csv”, “ppt”, “txt”, “pdf”, “png”, “jpg”, “gif”, “bmp”, “tiff”, “XML”, “BML”, “HTML” and “XHTML”, and whether or not the data to be printed has already been converted into print data (Step S202 in FIG. 4).

In the case where the data to be printed has already been converted into print data (that corresponds to the data format (8) in Table 1) (YES in Step S203 in FIG. 4), the processing goes to the print process to be performed by the printer engine in Step S212 in FIG. 4.

In the case where it has not been converted (NO in Step S203 in FIG. 4), the analysis unit 104 judges whether or not the data to be printed has the print style sheet applicable to the data itself. It is judged based on whether or not the style sheet name having the extension “xsl” or “css” is written in the data to be printed (Step S204 in FIG. 4). In the case where the applicable print style sheet exists (YES in Step S204 in FIG. 4), the print processing unit 105 generates print data based on the applicable style sheet (Step S205 in FIG. 4), and goes to the process in Step S212 in FIG. 4. In the case where the applicable style sheet does not exist (NO in Step S204 in FIG. 4), the analysis unit 104 judges whether or not the data to be printed includes text only (Step S206 in FIG. 4). It should be noted that in the case whether the print style sheet is written in the data to be printed, the analysis unit 104 searches the printing apparatus 1 and the terminal device that is the sender of the data to be printed so as to obtain the print style sheet associated with the data to be printed. In the case where no print style sheet is found as a result of the search, the analysis unit 104 goes to the process in Step S206 in FIG. 4 regarding that there is no applicable print style sheet.

In the case where the data to be printed includes text only (YES in Step S206 in FIG. 4), the print processing unit 105 generates print data by applying the style sheet A (S207 in FIG. 4), and the processing goes to Step S212 in FIG. 4. In the cases where the data to be printed is not the data which includes text only (NO in Step S206 in FIG. 4), the analysis unit 104 judges whether or not it includes image data only (Step S208 in FIG. 4).

In the case where the data to be printed includes image data only (YES in Step S208 in FIG. 4), the print processing unit 105 generates print data by applying the style sheet B (Step S209 in FIG. 4), and the processing goes to Step S212 in FIG. 4. In the case where the data to be printed is not the data which includes image data only (NO in Step S208 in FIG. 4), the analysis unit 104 judges whether or not it includes both text data and image data (Step S210 in FIG. 4).

In the case where the data to be printed includes both text data and image data (YES in Step S210 in FIG. 4), the print processing unit 105 generates print data by applying the style sheet C (Step S211 in FIG. 4), and the processing goes to Step S212 in FIG. 4. It should be noted that when the data to be printed includes both text data and image data, it is also possible to apply the print style for text data only to the text data and apply the print style for image data only to the image data, instead of applying the print style for mixed printing of text data and image data in a single page. In this case, when it is found, as a result of the analysis performed by the analysis unit 104, that the data to be printed includes both text data and image data, the printing apparatus 1 sends a user a notification indicating that the data to be printed includes both text data and image data, and inquires the user about his/her selection of one of the print processes: the print process to be performed by applying, to the data to be printed, the print style for mixed printing of text data and image data in a single page; and the print process to be performed by applying the print style for printing text data only to the text data and the print style for printing image data only to the image data.

When the data to be printed is not the data which includes both text data and image data, namely, when it is not possible for the print processing unit 105 to perform the print process on the data to be printed in accordance with a series of the above judgments (NO in Step S210 in FIG. 4), the printing apparatus 1 sends the terminal that transmitted the data to be printed a notification indicating that it is not possible to perform the print process on the data to be printed, or outputs the notification to the display unit (not illustrated in the drawings) of the printing apparatus so as to notify it to the user (Step S213 in FIG. 4).

The printer engine 108 receives the print data from the print processing unit 105, and performs the print process on that data (Step S212 in FIG. 4).

After the processes in Steps S212 and S213 in FIG. 4 are completed, the processes of analyzing the extension and markup language and judging whether printing is possible or not are terminated.

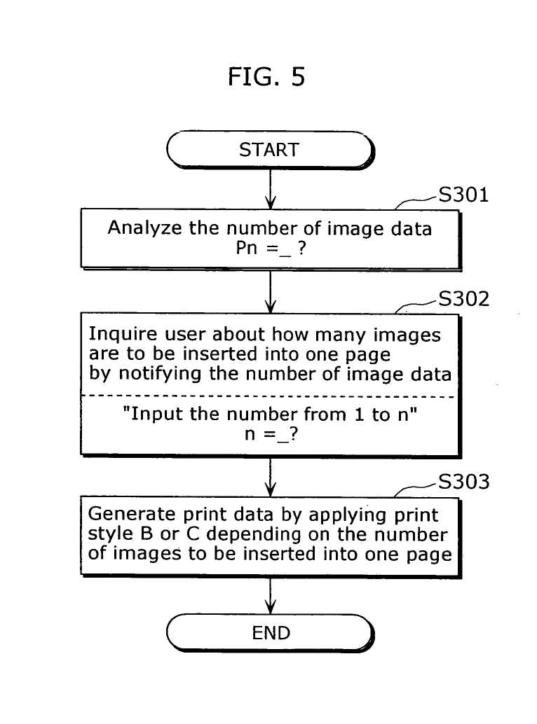

Next, analysis of the number of image data included in data to be printed is described below by referring to FIG. 5.

The print style to be applied to generation of print data is finally determined by performing this analysis of the number of image data on the data to be printed in the data formats (1), (2), (3), (5) and (7) shown in Table 1, which allows printing of data including both text data and image data, based on the analysis of the extension and markup language and the judgment of whether printing is possible or not. Note that this analysis is performed on the data in the data format (7) when the print style is not attached to that data.

First, the analysis unit 104 analyzes the number of image data included in the data to be printed, when the data to be printed includes image data only or includes both text data and image data as a result of the analysis of the extension and markup language and the judgment of whether printing is possible or not (Step S301 in FIG. 5).

The analysis unit 104 sends the analyzed number of image data to the controller 107. The controller 107 notifies the number of image data to the network terminal that is a sender of the data to be printed so as to inquire the user about how many images are to be inserted in one page. For example, the controller 107 displays “Input the number from 1 to n. p=_?” on the display unit of the network terminal, and the user inputs the number using the input unit. Here, it is also possible to substitute the display on the display unit (not illustrated in the drawing) of the printing apparatus 1 for the display on the display unit of the network terminal (Step S302 in FIG. 5).

It is preferable that a plurality of print styles B and a plurality of print styles C, which are used for printing data including image data, are respectively stored in the memory 106 in accordance with the number of images to be inserted into one page. The print processing unit 105 generates print data by applying the print style B or the print style C that is applicable to the number of image data for each page, and then the processing is terminated (Step S303 in FIG. 5).

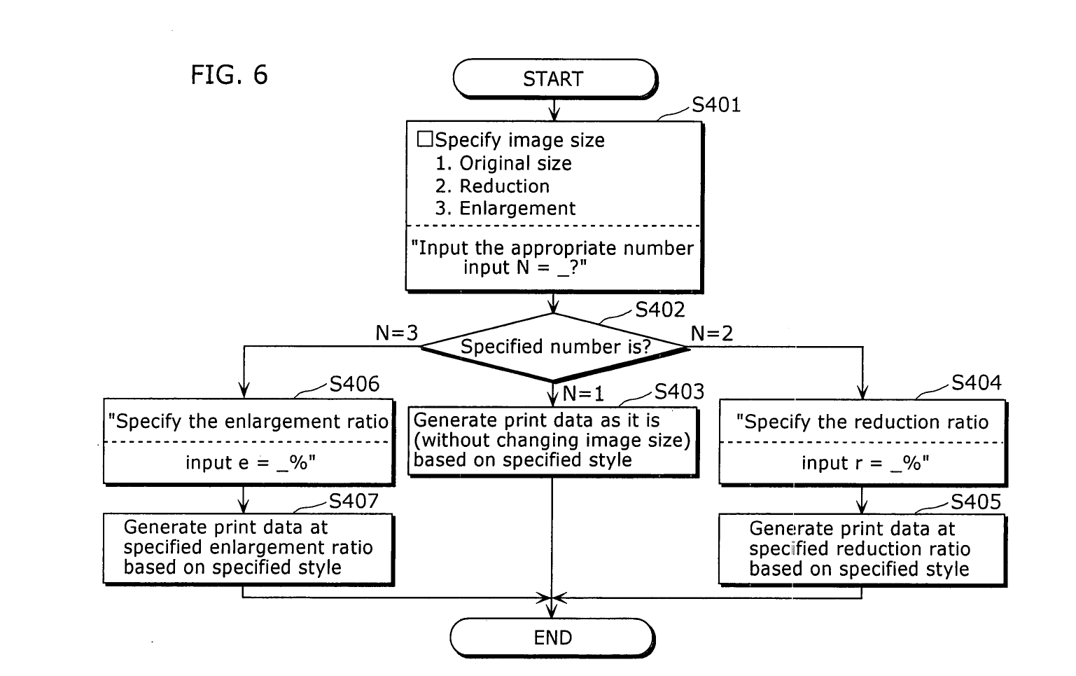

Next, adjustment of an image size included in data to be printed including only the image data or including both the image data and text data is described below by referring to FIG. 6.

When printing data to be printed including image data only or including both text data and image data, the printing apparatus 1 inquires the user about the size of an image to be inserted that is relative to the size of an original image. For example, it displays “Input the appropriate number: 1. Original size; 2. Reduction; 3. Enlargement”, via the network, on the display unit of the terminal that transmitted the data to be printed or the display unit (not illustrated in the drawing) of the printing apparatus 1, and the user inputs any of the numbers 1, 2 and 3 (Step S401 in FIG. 6). Then, the print processing unit 105 adjusts the image size and generates print data by applying the specified print style.

When the user selects “1. Original size” (N=1 in Step S402 in FIG. 6), the print processing unit 105 generates print data as it is (without changing the image size) by applying the specified print style (Step S403 in FIG. 6).

When the user selects “2. Reduction” (N=2 in Step S402 in FIG. 6), the printing apparatus 1 inquires the user about the reduction ratio. For example, the printing apparatus 1 displays “Specify the reduction ratio. input r=_%” on the display unit of the terminal that transmitted the data to be printed or the display unit (not illustrated in the drawing) of the printing apparatus 1 via the network, and the user inputs the reduction ratio (Step S404 in FIG. 6).

By applying the user-specified reduction ratio, the print processing unit 105 generates print data based on the specified print style (Step S405 in FIG. 6).

When the user selects “3. Enlargement” (N=3 in Step 402 in FIG. 6), the printing apparatus 1 inquires the user about the enlargement ratio. For example, the printing apparatus 1 displays “Specify the enlargement ratio. input e=_%” on the display unit (not illustrated in the drawing) of the terminal that transmitted the data to be printed or the display unit (not illustrated in the drawing) of the printing apparatus 1 via the network, and the user inputs the enlargement ratio (Step S406 in FIG. 6).

By applying the user-specified enlargement ratio, the print processing unit 105 generates print data based on the specified print style (Step S407 in FIG. 6).

The printing apparatus 1 generates the print data based on the specified print style after being size-adjusted, and terminates the adjustment of image size.

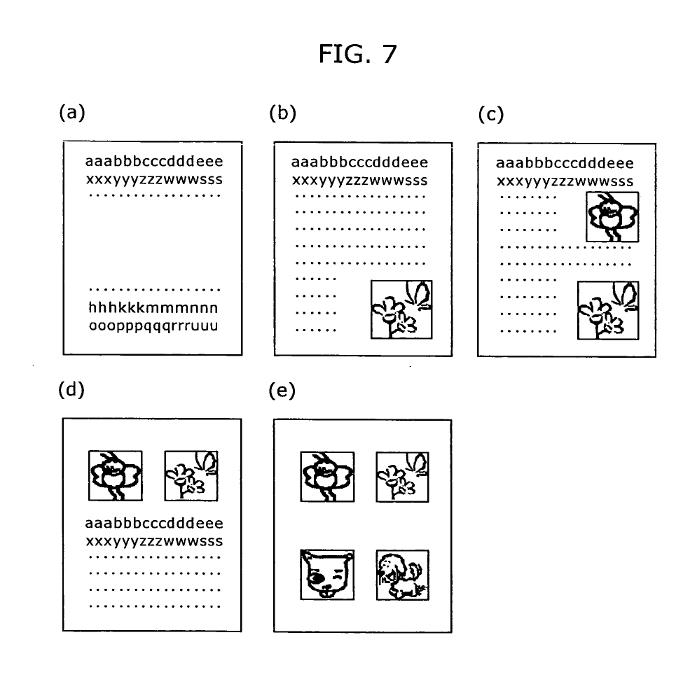

Next, examples of print data generated based on various print styles which are previously held in the memory 106 is described below by referring to FIG. 7.

In FIG. 7, (a) shows one example of print data which is printed based on a print style that corresponds to printing of text data only; (b) shows one example of print data which is printed based on a print style in which one image data is inserted into one page in the case of printing both text data and image data; (c) shows one example of print data which is printed based on a print style in which two image data are inserted into one page in the case of printing both text data and image data; (d) shows a variation of the print data shown in FIG. 7C; and (e) shows one example of print data which is printed based on a print style in which four image data are inserted into one page in the case of printing the image data only. It should be noted that it is also possible, in the case where data to be printed includes text data, to inquire a user about a font size and type and generate print data in accordance with the user-specified font size and style. However, the number of characters per page varies according to the user-specified font size and type, unlike the case where they are fixed. Therefore, it is preferable to hold not only the style sheets for the data formats (1) to (7) in Table 1 but also a plurality of style sheets applicable to font sizes and styles for each data format.

Furthermore, in the case where data to be printed includes both text data and image data, it is also possible to print the text data and the image data on separate pages. By doing so, it becomes possible to print the data so that the image data is printed out optimally when printing the image data and the text data is printed optimally when printing the text data.

As described above, according to the present invention, it is possible, like the conventional printing, for the printer driver of the personal computer 5 to generate print data that can be handled by the printer engine from data to be printed, and for the printer engine to receive the print data and print it, and it is also possible for the printing apparatus 1 to receive data to be printed together with the print style sheet that defines the print style for the data and generate print data. In addition, according to the present invention, even if the printing apparatus 1 receives the data to be printed with no style sheet, it is possible to generate print data for printing by applying an appropriate style sheet from among a plurality of style sheets previously stored in the memory 106 based on the analysis result of the data to be printed performed by the analysis unit 104. In more detail, since the markup language of data to be printed is analyzed so as to extract document data and image data that can be commonly handled and the print process is switched according to the format of the data to be printed, it becomes possible to provide a printing apparatus that supports various types of network terminals that transmit data to be printed written in various languages.

It should be noted that the above embodiment describes an example in which data to be printed is transmitted to the printing apparatus 1 using a communication function via the network 6, but the present invention is not limited to this example. For example, data to be printed may be moved from a network terminal to the printing apparatus 1 via a secure digital (SD) memory card that is a portable storage medium or the like. In other words, even if the data to be printed is transmitted to the printing apparatus 1 via such a portable storage medium, it is possible to select a printing method based on the result of analyzing the type of data to be printed and execute the print processing of the data.

Furthermore, in the case where a simple browser that supports various file formats is incorporated into the printing apparatus 1 and the simple browser identifies and previews the details of the data created by a plurality of different applications so as to apply the details of the data to printing, a part of information included in the data to be printed may be lost when creating print data, unless a print data creation process is executed as strictly as normal applications do. In order to print faithfully the data to be printed without any loss of the information included therein, nearly application-level program capacity is required for the simple browser. Therefore, there is no advantage in incorporating a simple browser.

According to the present embodiment, it is possible to incorporate a program of small capacity because there is no disadvantage of the above-mentioned simple browser, such as loss of information during printing and increase in program capacity caused by strict processing of application level for avoiding information loss. In addition, even if information (text data, image data and the like) included in data to be printed cannot be reproduced faithfully in accordance with the print style specified by the application, it is possible to reproduce such information without any loss by obtaining the information from the data to be printed by means of the above information obtaining unit and generating print data of the obtained information based on a provisional print style sheet which defines the print format and is previously stored in the memory.

Furthermore, according to the present embodiment, it is also possible to check a rough print of information included in the data to be printed, even though the information is not faithfully reproduced in accordance with the original print style specified by the application, transmit the data to be printed to a server or the like that holds the application that supports the data to be printed, and then execute full printing of the data to be printed in accordance with the original print style. By doing so, even if the application that supports the data to be printed is not installed into a network terminal, it becomes possible to check the details of the data to be printed without any loss of information included therein, which is very convenient.

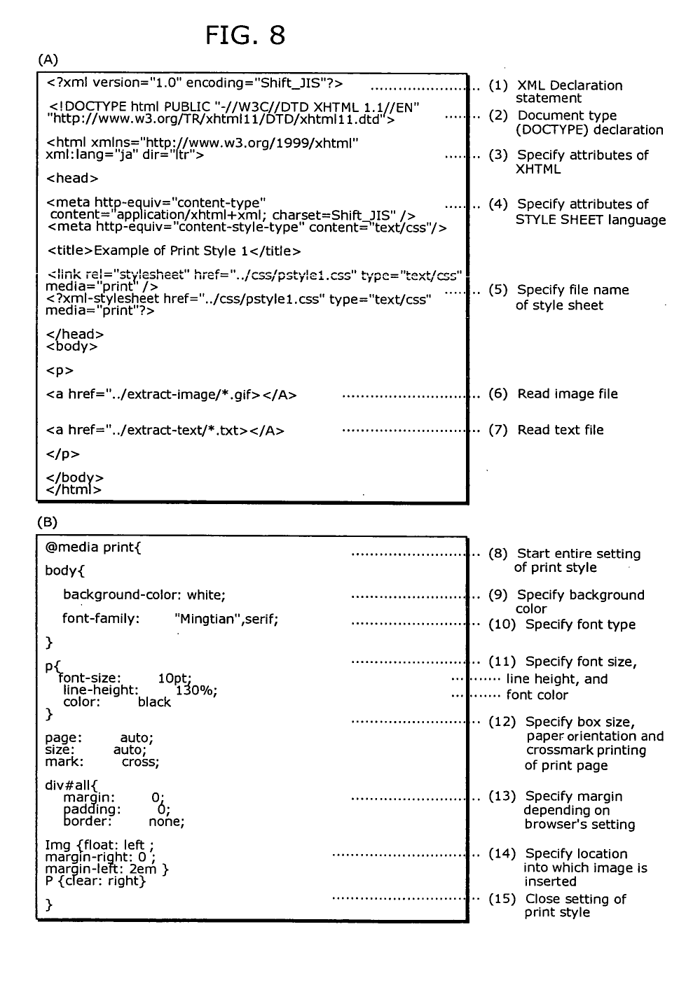

FIG. 8 shows one example of a print style sheet written in XHTML1.1. In FIG. 8, (A) shows one example of a definition written in XHTM1.1, and (B) shows one example of a CSS file (pstyle.css) that defines a print style.

In more detail, in FIG. 8, (1) is a declaration statement indicating that this document is written in XML. (2) is a declaration statement of a document type (DOCTYPE) of XHTML. (3) is an html element and a statement that specifies attributes of XHTML1.1. (4) is a statement that specifies attributes of style sheet language, and CSS is specified here. (5) specifies reading of an external style sheet (pstyle.css). (6) specifies reading of a file that holds image data (for example, *.gif) extracted from data to be printed. (7) specifies reading of a file that holds text data (for example, *.txt) extracted from the data to be printed.

Furthermore, in FIG. 8, (8) is a description indicating that the entire setting of a print style starts following a brace “{”. (9) specifies a background color, and white is specified here. (10) specifies a font type, and Mingtian is specified here. (11) specifies a font size, a line height and a font color. (12) specifies a box size, a paper orientation and crossmark printing of the print page. (13) specifies a margin and the like, and they shall depend on the browser's setting (i.e., they shall be separately specified) here. (14) specifies a location into which an image is inserted, and the image is placed on the right side of a page in the floating state using the float property and the following data (text data) is wrapped around to the left side of the page here. (15) is a description indicating that the setting of the print style is closed.

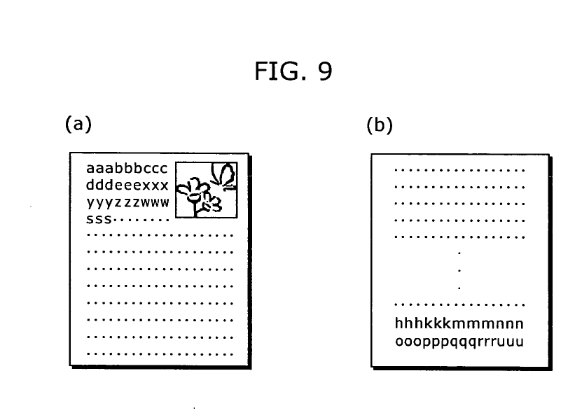

The image data and text data extracted from the data to be printed are printed by applying the print style as shown in FIG. 8, the pages as shown in FIG. 9 (a) and (b) are outputted. As shown in FIG. 9 (a), the image data is inserted, in the floating state, to the right side of the box (print range) on the print page. The text data is inserted into a space at the left of the image data until the end of the image data where the effect of the float property is cleared, and the text data which is pushed off the left space is inserted into the remaining space of the print page. In the case where one image data is extracted from the data to be printed, only the text data is inserted into the second page, as shown in FIG. 9 (b). Here, the size of the image data (*.gif) is adjusted appropriately so as to fit into the box of the print page after being extracted from the data to be printed. By doing so, the image data is placed appropriately within the print page, which allows printing of the image data without any loss of information included in the original image data.

It should be noted that the specific description of a print style that is shown here is just an example, and the present invention is not limited to this example.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The printing system according to the present invention is useful as a printing system for receiving data to be printed of various data types from a network terminal via a public network or a communication cable and printing the data to be printed. The printing apparatus according to the present invention is useful as an apparatus that receives data to be printed of various data types from a network terminal via a public network or a communication cable, generates print data, and output them for printing. The printing method according to the present invention is useful as a printing method for receiving data to be printed of various data types from a network terminal via a public network or a communication cable and printing the data to be printed. Furthermore, the program according to the present invention is useful as a program for causing a computer to function as the units included in a printing apparatus or a network terminal in a printing system for receiving data to be printed of various data types from the network terminal via a public network or a communication cable and printing the data to be printed.

1. A printing apparatus that is connected to a network terminal via a network, comprising:
a receiving unit operable to receive data to be printed from the network terminal, the data to be printed including at least one of image data and text data;
a print data generating unit operable to extract one of, or both, the image data and the text data from the received data to be printed, and generate print data that corresponds to the extracted data; and
a printing unit operable to perform printing of the generated print data.

2. The printing apparatus according to claim 1, further comprising
an analyzing unit operable to analyze whether a type of data included in the data to be printed is the image data or the text data,
wherein the print data generating unit generates the print data after performing a pre-process appropriate for the type of data based on a result of the analysis by the analyzing unit.

3. The printing apparatus according to claim 2,
wherein the analyzing unit analyzes the type of data based on a file extension included in the data to be printed.

4. The printing apparatus according to claim 2,
wherein the analyzing unit analyzes whether or not the data to be printed has already been converted into print data, based on a communication between the receiving unit and the network terminal.

5. The printing apparatus according to claim 4,
wherein in the case where the analyzing unit analyzes that the data to be printed has already been converted into print data, the printing unit performs printing of the data to be printed without any processing.

6. The printing apparatus according to claim 2,
wherein the analyzing unit further judges whether or not a print style of the data to be printed is predetermined.

7. The printing apparatus according to claim 6,
wherein in the case where the data to be printed includes a description of a file name with an extension indicating a style sheet that defines the print style, the analyzing unit judges that the style sheet with the file name is a style sheet that defines the predetermined print style of the data to be printed.

8. The printing apparatus according to claim 6, further comprising
a style sheet searching unit operable to (i) search the printing apparatus for a style sheet that defines the predetermined print style of the data to be printed in the case where the analyzing unit judges that said print style is predetermined, and (ii) request the network terminal that has transmitted the data to be printed to transmit the style sheet that defines the predetermined print style in the case where said style sheet is not found in the printing apparatus as a result of the search,
wherein the print data generating unit generates the print data based on the style sheet obtained as a result of the search or the request by the style sheet searching unit.

9. The printing apparatus according to claim 6, further comprising
a style sheet holding unit operable to hold a plurality of style sheets, each of which defines a specific print style for printing data to be printed depending on a type of data included in the data to be printed,
wherein the print data generating unit generates the print data according to a specific print style defined by one of the plurality of style sheets held in the style sheet holding unit, regardless of whether or not the print style of the data to be printed is predetermined.

10. The printing apparatus according to claim 6, further comprising
a style sheet holding unit operable to hold a plurality of style sheets, each of which defines a specific print style for printing data to be printed depending on a type of data included in the data to be printed,
wherein in the case where the analyzing unit judges that the print style of the data to be printed is not predetermined, the print data generating unit generates the print data according to a specific print style defined by one of the plurality of style sheets held in the style sheet holding unit.

11. The printing apparatus according to claim 10, further comprising
a selecting unit operable to receive, from a user, a selection of a style sheet to be used for generating print data of each type of data included in the data to be printed, from among the plurality of style sheets held in the style sheet holding unit,
wherein the print data generating unit generates the print data of the data to be printed, using the selected style sheet.

12. The printing apparatus according to claim 10,
wherein the style sheet holding unit holds at least a text style sheet that defines a print style for printing a text only and an image style sheet that defines a print style for printing an image only, and
in the case where the data to be printed includes both the text data and the image data, the print data generating unit (i) generates print data of the text data included in the data to be printed according to the print style defined by the text style sheet, and (ii) generates print data of the image data included in the data to be printed according to the print style defined by the image style sheet, so that the print data of the text data and the print data of the image data are printed on separate pages.

13. The printing apparatus according to claim 11,
wherein the selecting unit sends a notification to the user in the case where the data to be printed includes both the text data and the image data, and inquires the user about whether or not the image data and the text data should be printed on the same page.

14. The printing apparatus according to claim 13,
wherein in the case where the printing apparatus receives, as a result of the inquiry, an instruction from the user that the text data and the image data should not be printed on the same page, the print data generating unit (i) generates the print data for printing a text only from the text data included in the data to be printed, and (ii) generates the print data for printing an image only from the image data included in the data to be printed, so that the print data of the text data and the print data of the image data are printed on separate pages.

15. A printing system comprising a network terminal and a printing apparatus that are connected to each other via a network, the network terminal requesting the printing apparatus to print data to be printed, and the printing apparatus receiving the data to be printed from the network terminal and printing said data to be printed,
wherein the network terminal includes
a communicating unit operable to transmit the data to be printed to the printing apparatus via the network, and
the printing apparatus includes:
a receiving unit operable to receive the data to be printed from the network terminal, the data to be printed including at least one of image data and text data;
a print data generating unit operable to extract one of, or both, the image data and the text data from the received data to be printed, and generate print data that corresponds to the extracted data; and
a printing unit operable to perform printing of the generated print data.

16. The printing system according to claim 15,
wherein the printing apparatus further includes
an analyzing unit operable to analyze whether a type of data included in the data to be printed is the image data or the text data,
wherein the print data generating unit generates the print data after performing a pre-process appropriate for the type of data based on a result of the analysis by the analyzing unit.

17. The printing system according to claim 16,
wherein the network terminal further includes
a print data generation notifying unit operable to send a notification to the communicating unit in the case where the network terminal has already generated the print data from the data to be printed,
the analyzing unit analyzes whether or not the data to be printed has already been converted into the print data in the network terminal, based on a communication between the receiving unit and the communicating unit, and
the printing unit performs printing of the data to be printed without any processing in the case where the data to be printed has already been converted into the print data.

18. The printing system according to claim 16,
wherein the printing apparatus further includes
a style sheet holding unit operable to hold at least a text style sheet that defines a print style for printing a text only and an image style sheet that defines a print style for printing an image only, and
the print data generating unit generates the print data according to a print style defined by one of the style sheets held in the style sheet holding unit, depending on a type of data included in the data to be printed.

19. The printing system according to claim 16,
wherein the analyzing unit judges whether or not a print style of the data to be printed is predetermined, based on whether or not the data to be printed includes a description of a file name with an extension indicating a style sheet.

20. The printing system according to claim 19,
wherein the network terminal further includes:
a memory operable to hold the data to be printed and a style sheet that defines the print style of the data to be printed; and
a searching unit operable to search the memory for the style sheet when receiving a request for said style sheet from the printing apparatus, the printing apparatus further includes:
a style sheet holding unit operable to hold at least a text style sheet that defines a print style for printing a text only and an image style sheet that defines a print style for printing an image only; and
a style sheet searching unit operable to (i) search the style sheet holding unit for a style sheet that defines the predetermined print style of the data to be printed in the case where the analyzing unit judges that said print style is predetermined, and (ii) request the network terminal that has transmitted the data to be printed to transmit the style sheet that defines the predetermined print style of the data to be printed in the case where said style sheet is not found in the style sheet holding unit as a result of the search, and
the print data generating unit generates the print data based on the style sheet obtained as a result of the search or the request by the style sheet searching unit.

21. The printing system according to claim 19,
wherein the printing apparatus further includes
a style sheet holding unit operable to hold at least a text style sheet that defines a print style for printing a text only and an image style sheet that defines a print style for printing an image only,
the network terminal further includes:
a displaying unit operable to display style sheets held in the style sheet holding unit; and
an inputting unit operable to input a style sheet selected by a user from among the displayed style sheets, and
in the printing apparatus, the print data generating unit generates the print data according to a print style defined by the style sheet selected by the user in the case where the analyzing unit judges that the print style of the data to be printed is not predetermined.

22. The printing system according to claim 19,
wherein the network terminal further includes
an inquiring unit operable to send a notification to a user in the case where the data to be printed includes both the text data and the image data, and inquire the user about whether or not the image data and the text data should be printed on the same page, and
in the case where the printing apparatus receives, as a result of the inquiry by the inquiring unit, an instruction from the user that the text data and the image data should not be printed on the same page, the print data generating unit (i) generates the print data for printing a text only from the text data included in the data to be printed, and (ii) generates the print data for printing an image only from the image data included in the data to be printed, so that the print data of the text data and the print data of the image data are printed on separate pages.

23. A printing method by which a network terminal transmits data to be printed and a request for printing the data to be printed to a printing apparatus via a network and the printing apparatus receives and prints said data to be printed, the method comprising:
in the network terminal,
transmitting the data to be printed to the printing apparatus via the network;
in the printing apparatus,
receiving the data to be printed from the network terminal, the data to be printed including at least one of image data and text data;
extracting one of, or both, the image data and the text data from the received data to be printed, and generating print data that corresponds to the extracted data to be printed; and
printing the generated print data.

24. The printing method according to claim 23, further comprising
in the printing apparatus, analyzing whether a type of data included in the data to be printed is the image data or the text data,
wherein in the generation of the print data, said print data is generated after being pre-processed appropriately for the type of data based on a result of the analysis.

25. The printing method according to claim 24,
wherein it is judged in the analysis whether or not a print style of the data to be printed is predetermined.

26. The printing method according to claim 25,
wherein in the printing apparatus, at least a text style sheet that defines a print style for printing a text only and an image style sheet that defines a print style for printing an image only are previously held in a style sheet holding unit, and
in the generation of the print data, the print data is generated according to a print style of one of the held style sheets, in the case where it is judged in the analysis that the print style of the data to be printed is not predetermined.

27. The printing method according to claim 25,
wherein in the network terminal, the data to be printed and a style sheet that defines a print style of the data to be printed are previously held in a memory,
in the printing apparatus, at least a text style sheet that defines a print style for printing a text only and an image style sheet that defines a print style for printing an image only are previously held in a style sheet holding unit,
the method further comprising:
(i) searching the style sheet holding unit for the style sheet that defines the predetermined print style of the data to be printed in the case where it is judged in the analysis that said print style is predetermined, and (ii) requesting the network terminal that has transmitted the data to be printed to transmit the style sheet that defines the predetermined print style in the case where said style sheet is not found in the style sheet holding unit; and
searching the memory for the style sheet when receiving the request for said style sheet from the printing apparatus, and
in the generation of the print data, the print data is generated based on the style sheet obtained as a result of the search or the request.

28. The printing method according to claim 26, further comprising
in the network terminal, sending a notification to a user in the case where the data to be printed includes both the text data and the image data, and inquiring the user about whether or not the image data and the text data should be printed on the same page,
wherein in the case where, as a result of the inquiry, the printing apparatus receives an instruction from the user that the text data and the image data should not be printed on the same page, in the generation of the print data, (i) the print data is generated for printing a text only from the text data included in the data to be printed, and (ii) the print data is generated for printing an image only from the image data included in the data to be printed, so that the print data of the text data and the print data of the image data are printed on separate pages.

29. A network terminal that transmits data to be printed and a request for printing the data to be printed to a printing apparatus via a network so as to cause the printing apparatus to print said data to be printed, comprising:
a communicating unit operable to transmit the data to be printed to the printing apparatus;
a memory operable to hold the data to be printed and a style sheet that defines a print style of the data to be printed;
a style describing unit operable to describe a file name with an extension indicating the style sheet on the data to be printed; and
a searching unit operable to search the memory for the style sheet when receiving a request for said style sheet from the printing apparatus.

30. A program for a printing apparatus that is connected to a network terminal via a network, the program causing a computer to function as:
a receiving unit operable to receive data to be printed from the network terminal, the data to be printed including at least one of image data and text data;
a print data generating unit operable to extract one of, or both, the image data and the text data from the received data to be printed, and generate print data that corresponds to the extracted data; and
a printing unit operable to perform printing of the generated print data.

31. A program for a network terminal that transmits data to be printed and a request for printing the data to be printed to a printing apparatus via a network so as to cause the printing apparatus to print said data to be printed, the program causing a computer to function as:
a communicating unit operable to transmit the data to be printed to the printing apparatus;
a memory operable to hold the data to be printed and a style sheet that defines a print style of the data to be printed;
a style describing unit operable to describe a file name with an extension indicating the style sheet on the data to be printed; and
a searching unit operable to search the memory for the style sheet when receiving a request for said style sheet from the printing apparatus.
